(19) United States
(12) Patent Application Publication
(10) Pub. No.: US 2009/0142742 A1
(43) Pub. Date: Jun. 4, 2009

(54) Analysis for Assessing Test Taker Responses to Puzzle-Like Questions

(76) Inventor: Adele Goldberg, Palo Alto, CA (US)

Correspondence Address: ADELI & TOLLEN, LLP, 11940 San Vicente Blvd, Suite 100, LOS ANGELES, CA, 90049, US

(21) Appl. No.: 11/947,766

(22) Filed: Nov. 29, 2007

(51) Int. Cl. G09B 7/02

(52) U.S. Cl. 434/362

(57) ABSTRACT

Some embodiments of the invention provide computer-delivered curriculum content to a student. The curriculum of some embodiments includes learning interactions that are designed to give a student substantive feedback when the student provides a response to a “puzzle-like” question. Puzzle-like questions are questions that have a solution space with a relatively large number of potential responses (e.g., with more than one correct answer or partially correct answer or partially incorrect response or incorrect response). Some embodiments provide assessment analysis for the puzzle-like questions. When a test taker provides an incorrect response or a partially correct response, for example, some embodiments present to the test taker prestored feedback regarding the particular misunderstanding that is associated with the response in order to explain the possible misunderstanding. Some embodiments perform the assessment analysis for puzzle-like questions by using a rule-based technique to describe multiple acceptable responses (e.g., one or more completely correct answers and one or more partially correct answers). Rules can be specified to associate commentary to different possible responses. Some embodiments embed the rules in an XML format that is utilized at runtime.

### STATEMENT REGARDING FEDERALLY SPONSORED RESEARCH AND DEVELOPMENT

One or more of the inventions discussed below were developed partly with funds procured from the U.S. Government pursuant to NSF Grant No. 0441519. Accordingly, the U.S. Government may have certain rights to this invention pursuant to NSF Grant No. 0441519.

### FIELD OF THE INVENTION

The present invention relates to analysis of test taker responses to assessment tasks.

### BACKGROUND OF THE INVENTION

Numerous tools and techniques have been suggested in recent years to assist teachers in their work. A critical issue in educating teachers is how to teach prospective or existing teachers to make sense of what their students do. One kind of situation that the teachers have to make sense of is the many ways in which their students perform on tests. The ability to assign meaning to different possible responses to questions on a test is a sub-problem to the more general critical issue. Increasing teachers' ability to respond to misunderstandings is important to teachers who wish to do a better job of teaching. It can also be important to the education administrators who wish to see improvements in their students' performance on high-stakes accountability exams.

Assessments are among the tools that are employed by teachers to help them evaluate test taker responses in order to identify misunderstandings. Such evaluation can assist teachers in planning instructional lessons on an individual student and/or group basis. Some assessment tools utilize adaptive testing and/or artificial intelligence algorithms that perform computations and retrieve instructional comments based on some scoring system. As such, these tools are often highly complex and can be very expensive. These algorithmic tools typically provide an assessment of a particular test taker's response to a particular question based on other test takers' responses to the particular question or the particular test taker's responses to other questions.

Some assessment tools utilize distractor analysis. In these tools, distractor analysis employs prompts. Prompts offer response options that, when effectively designed, reflect common misconceptions in the learning process. Ideally, if the test taker chooses one of these prompts, the decision to do so reflects a misunderstanding that is experienced by many learners and is explainable. The prior tools perform distractor analysis based only on a single response to a single question, as these tools typically perform such distractor analysis only for Multiple-Choice Single-Answer (“MCSA”) questions, each of which consists of a set of independent prompts, each prompt representing either the single correct response or one for which the misunderstanding is identifiable.

Therefore, there remains a need in the art for a method that provides a cost-efficient, reliable technique for identifying a test taker's potential misunderstandings on questions that are more complex than MCSA questions. The complexity comes from the inability to enumerate, as explicitly as can be done in an MCSA question, each possible response, and, just as explicitly, to align misunderstandings with these responses. Ideally, such an identification method can analyze an individual response submitted by a test taker and provide an appropriate feedback to that test taker, or to an interested teacher, administrator and/or any other individual.

### SUMMARY OF THE INVENTION

Some embodiments of the invention provide computer-delivered curriculum content to a test taker. The curriculum of some embodiments includes learning interactions that are designed to give a test taker substantive feedback when the test taker provides a response that represents a correct answer, an incorrect answer, a partially correct answer, and/or partially incorrect answer to a question that might be a complex, “puzzle-like,” question. Specifically, the learning interactions of some embodiments include multiple choice single answer (MCSA) questions, multiple choice multiple answer (MCMA) questions, fill-in-the-blank (FIB) questions, drag and drop (DND) questions, and/or questions of similar complexity as measured by the number of possible test taker responses.

Except for MCSA questions, the other question types are complex, puzzle-like questions in that they have a solution space with a relatively large number of potential responses. For instance, puzzle-like questions may have multiple possible correct answers and/or possible responses that come in multiple parts so that the test taker can submit correct answers for one or more parts but not all. Puzzle-like questions typically lend themselves to less guessing or random response, often seen as a problem with MCSA type questions; puzzle-like questions can be more engaging as they offer the potential for greater challenge and should offer a better basis for evaluation.

Some embodiments provide assessment analysis for the puzzle-like questions. For instance, when the test taker provides a response, some embodiments present to the test taker prestored feedback regarding the particular misunderstanding that is associated with the anticipated incorrect answer or anticipated partially correct or incorrect answer, in order to explain the possible misunderstanding. The difference in labeling an answer as “partially correct” or “partially incorrect” is a pedagogical one as it depends on what the author of the question wishes to highlight (i.e., the portion of the response that was right or that was wrong).

In situations in which a complete enumeration of anticipated responses is possible, prior assessment tools can and have offered explanations about probable misunderstandings associated with each enumerated response by using a simple one-to-one match that does not solve the problem posed by the complexity of puzzle-like questions. In some embodiments of the invention, to solve the complexity problem for puzzle-like questions where a complete enumeration is not possible, a rule-based technique is used to perform the assessment analysis. By using a rule-based technique, these embodiments of the invention describe anticipated responses implicitly rather than through full enumeration. The question specification provides one or more rule sets that can be used to categorize multiple possible responses. These rule sets can then be used to categorize the responses as completely correct or incorrect answers and/or partially correct or incorrect answers. Rule sets could reduce to a one-to-one match, but the point here is that a rule set can be designed to match an arbitrarily large number of possible student responses, without enumerating all possible such responses.

For example, in DND questions, some embodiments use rules to specify the different combinations in which tiles might correctly match with slots, including matching multiple tiles to the same slot or a single tile to multiple slots. Rules could also be used to recognize different combinations in which tiles might be matched to slots by the test taker, even though the combinations are not acknowledged to be one of the acceptably correct answers. For FIB questions, some embodiments define sets of words or phrases, and then use rules to define how these words or phrases might be typed into blanks placed in tables, sentences, or picture labels to produce correct answers.

Some embodiments associate commentary with one or more of the rule sets. Some of these embodiments then provide this commentary after matching a test taker's response to a rule set that is associated with a correct or incorrect answer or a partially correct or incorrect answer. The commentary associated with incorrect or partially correct/incorrect answers is meant to highlight possible misunderstandings of the test takers. Some embodiments embed the rules in an XML format that is utilized at runtime to direct real-time analysis of responses and to provide immediate feedback to the test taker. Such analysis can be referred to as “real-time distractor analysis”. Some embodiments also capture the analyses for later reporting to test takers, question authors, teachers, and/or administrators.

### BRIEF DESCRIPTION OF THE DRAWINGS

The novel features of the invention are set forth in the appended claims. However, for purpose of explanation, several embodiments are set forth in the following figures.

FIGS. 1-3 illustrate a test taker's experience in seeing a display of and interacting with a DND question as provided in some embodiments of the invention.

FIG. 4 illustrates an example of a picture-style DND question.

FIG. 5 illustrates an example of a table-style DND question.

FIGS. 6-7 illustrate a test taker's experience in seeing a display of and interacting with a FIB question as provided in some embodiments of the invention.

FIGS. 8-9 illustrate a test taker's experience in seeing a display of and interacting with an MCMA question of some embodiments of the invention.

FIG. 10 conceptually illustrates an authoring process of some embodiments.

FIG. 11 illustrates an initial presentation of an MCMA question.

FIG. 12 illustrates the presentation of the MCMA question after the test taker has provided a response that matches the correct answer.

FIG. 13 illustrates a DND example.

FIG. 14 illustrates the same question that was described in FIGS. 1-3.

FIG. 15 illustrates an initial presentation of a FIB question.

FIG. 16 illustrates the presentation of the FIB question after the test taker has filled in the blanks and submitted the response.

FIG. 17 presents a software architecture diagram that illustrates how some embodiments display a set of questions to a test taker and record the test taker's interactions in responding to the question.

FIG. 18 illustrates a real-time analysis process that the browser's Flash player performs in some embodiments.

FIG. 19 illustrates some embodiments that use multiple databases to form the data store 1750 of FIG. 17.

FIG. 20 illustrates an example of reviewing question-level analysis of a test for multiple test takers.

FIG. 21 illustrates a similar report, generated for the same search criteria that were specified in the example of FIG. 20.

### DETAILED DESCRIPTION OF THE INVENTION

In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail.

### I. OVERVIEW

Some embodiments of the invention provide computer-delivered curriculum content to a test taker (e.g., student). The curriculum of some embodiments includes tests or assessments made up of learning interactions that are designed to give the test taker substantive feedback when the test taker provides a response to a “puzzle-like” question.

Specifically, the learning interactions of some embodiments can include multiple-choice single-answer (MCSA) questions, multiple-choice multiple-answer (MCMA) questions, fill-in-the-blank (FIB) questions, and drag and drop (DND) questions, and/or questions of similar complexity as measured by the number and variety of possible test taker responses. Except for MCSA questions, the other question types are complex, puzzle-like questions. Puzzle-like questions are questions that have a solution space with a relatively large number of potential responses (including the possibility of more than one correct answer). For instance, puzzle-like questions may have multiple possible correct answers and/or correct answers that come in multiple parts. The complexity in analyzing a test taker's response to a puzzle-like question comes from the potentially large number of different responses (e.g., combinations of ways in which the test taker can provide responses for different multiple parts) and the varying ways in which different combinations have sub-parts that are correct while others are not correct. To tell the test taker that the response is not correct when parts are correct could be pedagogically unsound.

In the case of multiple possible correct answers, one or more correct answers might be more correct than others. For instance, one test taker response might be completely correct while the other responses are only partially correct or incorrect. Alternatively, one response might be fully correct but different feedback to the test taker would be more appropriate. For instance, in the case of MCMA questions, prompts A and B might both be correct while prompts C and D might be incorrect. Of the two correct prompts, prompt A might be more correct than B, or prompts A and B might be both completely correct. In each case, the author might wish to give the test taker different feedback. Alternatively, it is possible to define the question such that both A and B must be selected so that the correct answer is really the combination of both A and B. In this case, the author of the question might wish to give the test taker different feedback if A is selected in combination with C or D, or B is selected in combination with C or D, etcetera.

As mentioned above, some embodiments include DND and FIB questions in addition to MCMA questions. DND problems are those in which the test taker matches tiles to slots (where those slots might be areas embedded, for example, in an image, a table or a sentence). FIB problems are those in which the test taker provides input from a real or virtual keyboard, typing into one or more slots. In this case, there are likely no tiles and the slots might appear as blank input boxes.

Some embodiments provide such MCSA, MCMA, DND, and FIB content by specifying each intended screen of information in a particular format (e.g., XML format). This format is then interpreted by a computer program that executes to generate screens that display the questions to the learner. In presenting these questions, the computer program in some embodiments may call other programs, such as a media player or a Flash player.

As mentioned earlier, a test taker can respond to a puzzle-like question in a large number of ways. As a consequence, the question could have one or more correct answers, one or more partially correct or incorrect answers, and/or one or more incorrect answers. Each partially correct or incorrect answer can be categorized into a set of potential answers, which can be identified with a particular misunderstanding. When the test taker provides a response that matches a rule set for incorrect, partially correct, or partially incorrect answers, some embodiments present to the test taker prestored feedback that is associated with the rule set in order to explain the possible misunderstanding.

Some embodiments perform an assessment analysis for puzzle-like questions by using a rule-based technique to describe multiple possible expected responses. For example, in DND questions, some embodiments use rules to specify the different combinations in which tiles might be matched with slots, including matching multiple tiles to the same slot or a single tile to multiple slots. For FIB questions, some embodiments define sets of words or phrases, and use rules to further define how the words or phrases might be combined to complete tables or sentences, or to label parts of pictures. Rules can be defined to specify partially right responses or to associate commentary to different possible wrong responses. Some embodiments embed the rules in an XML format that is utilized at runtime.

Some embodiments save the test taker's actual response in a data store (e.g., database or file) along with the circumstances surrounding the response. These circumstances can include screen identification, number of tries the test taker has been given and taken to come up with this response, the display of a hint, the time of day a response is given, the evaluation of the response as correct or not, and the actual response provided by the test taker.

Based on these stored data, some embodiments perform further analysis in order to provide teachers, administrators, and/or other individuals with feedback regarding the misunderstanding of one or more test takers. For instance, some embodiments provide teachers and/or administrators with comprehensive reports on a particular test taker's responses in a particular test, on the particular test taker's responses in multiple tests, multiple test takers' responses in a particular test, and multiple test takers' responses in multiple different tests. Reading these reports, the teacher or administrator can review possible misunderstandings that a particular test taker or multiple test takers had in responding to a particular question or in responding to several different questions.

Examples of one such report is provided in Section V. However, before describing reports, Section II provides several examples of puzzle-like questions, Section III describes the authoring of such questions in some embodiments making use of the invention, and Section IV describes display of the questions to a test taker.

### II. EXAMPLES

### A. Definition of Different Questions Types

In some embodiments, an MCMA question is a multiple choice question that requires a test taker to choose more than one response selection. In some embodiments, each response selection is provided as a box that the test taker chooses by placing a check within it. Other embodiments use other user input and visual feedback devices.

In some embodiments, a DND question is a question in which the test taker has to match labeled tiles to areas (e.g., rectangles), sometimes called “slots”, which might be embedded in an image, a table, a sentence, or other structure. One or more tiles might be placed in a single slot; the same tile might be copied to multiple slots. In some questions, some tiles might not match any slot, while in some other questions some slots might have no matching tiles.

In some embodiments, a FIB question is a question in which the test taker provides input from a real or virtual keyboard into one or more slots that are displayed as input fields. Examples of each of these question types are provided below.

### B. DND Example

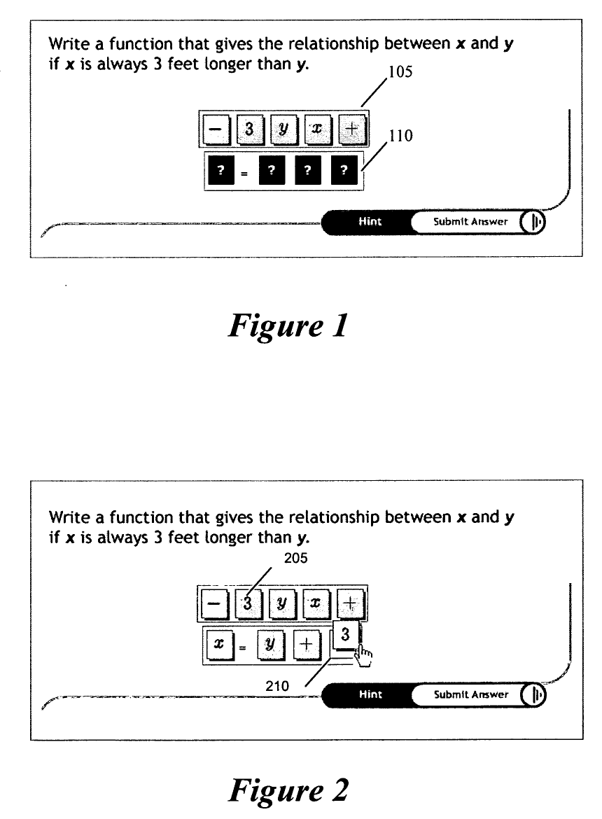

FIGS. 1-3 illustrate a test taker's experience in seeing a display of and interacting with a DND question as provided in some embodiments of the invention. Specifically, FIG. 1 illustrates an example of a DND question that is presented to a test taker. This DND question is displayed in a “sentence style” format. This example includes five tiles 105 that need to be dragged and dropped by the test taker into four slots 110. Once placed into the four slots, the tiles should express that x is always 3 feet longer than y.

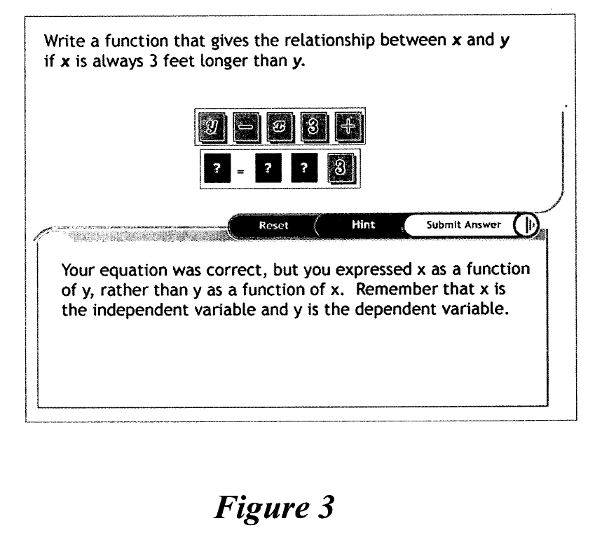

FIG. 2 illustrates the dragging of the final tile 205 into slot 210 to create an equation x=y+3. FIG. 3 then illustrates the result of an analysis that is performed for the test taker's response x=y+3. As shown in this figure, the result of this analysis is real-time feedback to the test taker that the test taker's response is correct but expresses x as a function of y rather than expressing y as a function of x (Note in this embodiment, incorrect tiles are removed as a hint to the test taker).

Some embodiments of the invention use a rule-based XML technique to formulate the DND question illustrated in FIGS. 1-3. One XML implementation of this question and its associated rules will be further described in Section III.

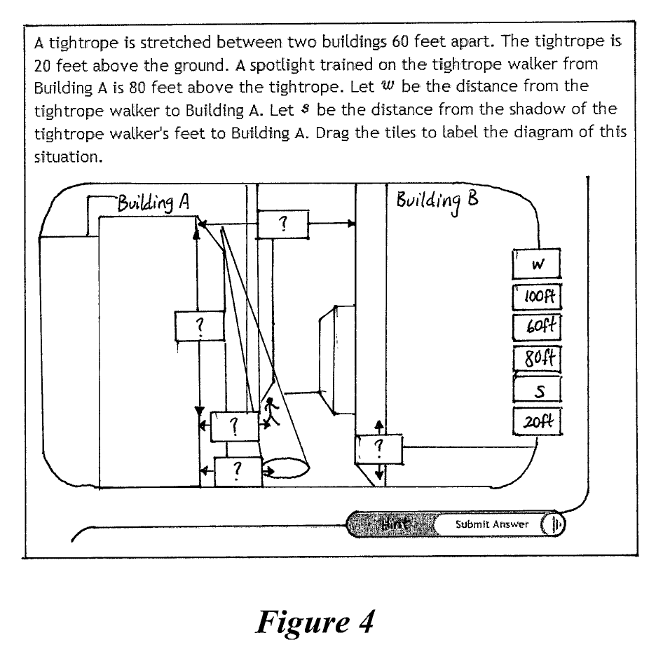

Some embodiments use other DND question formats in conjunction with or instead of the sentence style format. Two examples of such other formats are the picture-style format and the table-style format. For instance, FIG. 4 illustrates an example of a picture-style DND question. As shown in this figure, the test taker has to drag and drop tiles into slots that are incorporated into a picture.

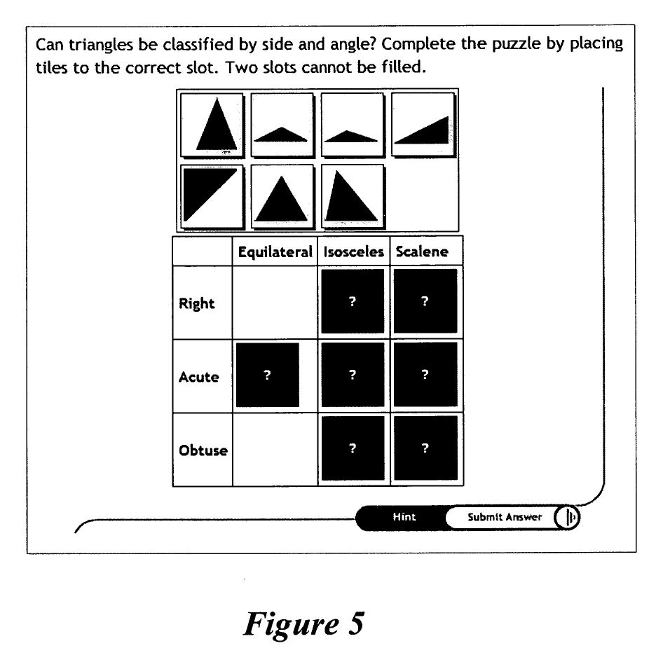

FIG. 5 illustrates an example of a table-style DND question. As shown in this figure, the test taker has to drag and drop tiles into slots that are located within cells of a table.

### C. FIB Example

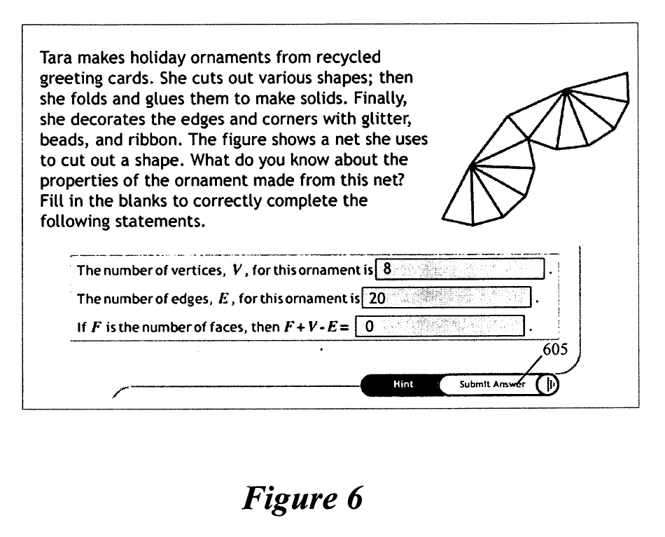

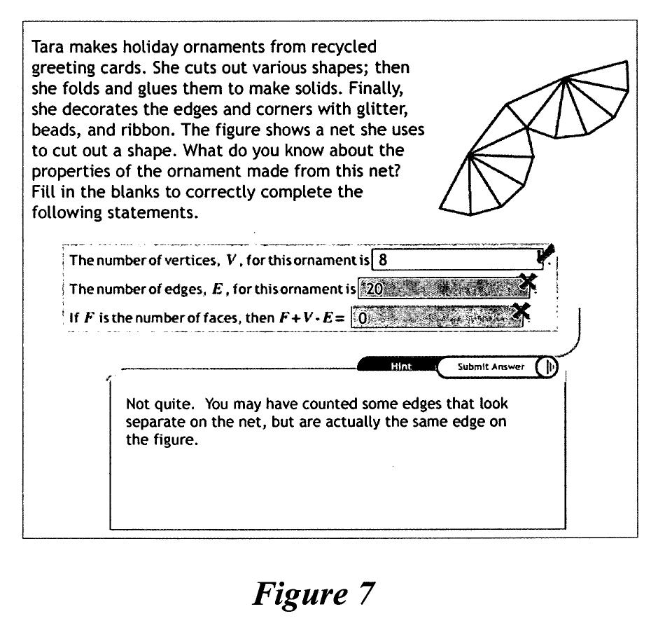

FIGS. 6-7 illustrate a test taker's experience in seeing a display of and interacting with a FIB question of some embodiments of the invention. Specifically, FIG. 6 illustrates an example of a FIB question that is presented to a test taker. In this example, a test taker is asked to fill in three blanks with the numbers of vertices, edges, and faces of a particular object. FIG. 6 illustrates the test taker providing 8, 20, and 0 as the respective number of vertices, edges, and faces.

Once the test taker selects the “submit” response option 605 in FIG. 6 (or some other user interface way to indicate that the response is completed and should be analyzed), an analysis is performed on the test taker's response. This analysis matches the test taker's response with a rule pattern representing an incorrect anticipated response. The test taker's response in this example might have resulted from the test taker mistakenly counting the number of edges and faces. As shown in FIG. 7, this analysis also results in feedback to the test taker that indicates that the test taker might have miscounted an edge as multiple edges.

Some embodiments of the invention use a rule-based XML technique to define the FIB question illustrated in FIGS. 6-7. In some embodiments, the analysis can provide the feedback illustrated in FIG. 7 because the rule-based XML specification of this question includes the response of twenty edges as a part of an incorrect response that a test taker might provide. The XML specification also associates feedback commentary with this potentially incorrect response. This feedback commentary is based on an author of the question identifying (1) a misconception that might result in the incorrect response, and (2) the feedback to provide to the test taker to address this misconception. The authoring of this question and its associated misconceptions will be further described below in Section III.

### D. MCMA Example

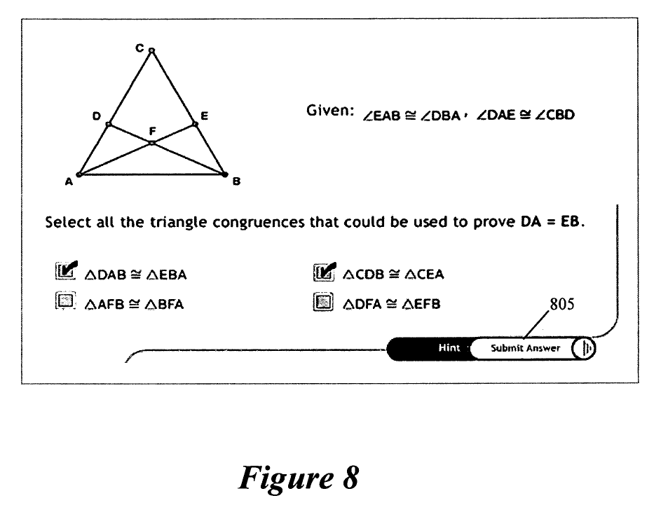

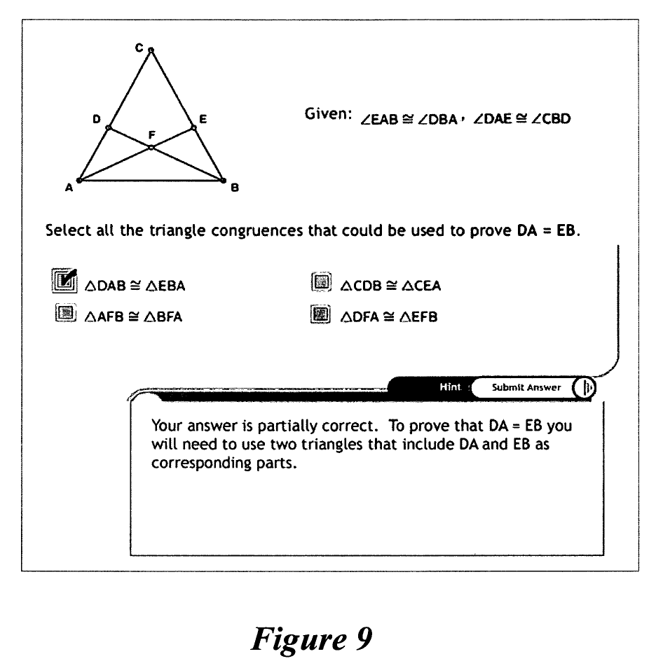

FIGS. 8-9 illustrate a test taker's experience in seeing a display of and interacting with an MCMA question using some embodiments of the invention. Specifically, FIG. 8 illustrates an example of an MCMA question that is presented to a test taker. In this example, the test taker is asked to select all answers that show the congruence of two triangles, where the congruence can be used to prove that two segments of the triangle have the same length.

Once the test taker selects the “submit” option 805 in FIG. 8 (or uses some other interaction mechanism to indicate that the response should be submitted for analysis), an analysis is performed on the test taker's response. This analysis matches the test taker's response with a rule pattern representing a partially correct response. As shown in FIG. 9, this analysis also results in feedback to the test taker that indicates that the test taker's response is only partially correct as the test taker should have selected a different prompt describing two triangles that include the two equal-length segments.

Some embodiments of the invention use a rule-based XML technique to define the MCMA question illustrated in FIGS. 8-9. In some embodiments, the analysis can provide the feedback illustrated in FIG. 9 because the rule-based XML specification of this question includes rules that define a potential incorrect response that a test taker might provide. This incorrect response specifies that triangles CDB and CEA are congruent. The XML specification also associates feedback commentary with this potentially incorrect response. This feedback commentary is based on an author of the question identifying (1) a misconception that might result in the incorrect response, and (2) the feedback to provide to the test taker in order to address this misconception. The authoring of this question and its associated misconceptions will be further described in Section III.

### III. AUTHORING

As mentioned above, some embodiments use a rule-based technique to define questions and to perform assessment analysis on the test taker's responses to the questions. For puzzle-like questions, this rule-based technique can be used (1) to identify correct, partially correct or incorrect, and/or incorrect answers; and (2) to specify potential misunderstandings or misconceptions associated with responses that match rules.

Section IIIA describes a process for authoring a rule-based question. Section IIIB then provides an overview of the rules that some embodiments use to specify questions and the assessment analysis for questions. Section IIIC then provides several examples that illustrate the use of these rules.

### A. Overall Flow

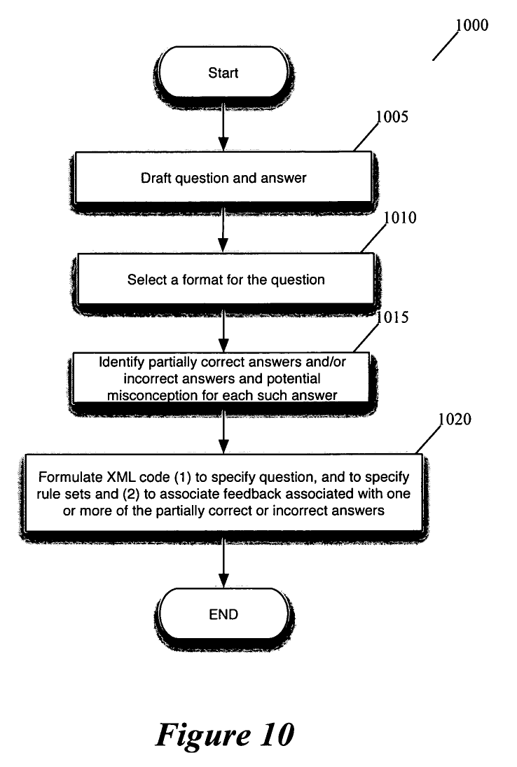

FIG. 10 conceptually illustrates an authoring process 1000 of some embodiments. This process formulates a puzzle-like question and associates feedback commentary to one or more possible sets of responses that might be given by test takers. This process uses a rule-based approach to specify a puzzle-like question. As further described below, this process uses a human author to write the question, identify potential responses, and provide appropriate feedback commentary associated with groupings (or sets) of responses as defined by the rules. The same person or another (e.g., a production assistant) then creates source code specification of the question in XML. In other words, the code in XML defines the rules that form the basis for analyzing responses to questions, specifies sets of potential answers including ones that are incorrect, partially correct, or partially incorrect, and specifies commentary associated with the possible responses that match the rules.

As shown in FIG. 10, the process 1000 initially starts (at 1005) when an author drafts a puzzle-like question and specifies one or more completely correct answers to this question.

At 1010, the author selects a format for the question. In some embodiments, the formats that the author selects from include MCSA, MCMA, DND, and FIB, as described earlier.

Next, the author identifies (at 1015) one or more partially correct or incorrect answers and/or one or more incorrect responses that the test taker might provide in response to this question. At 1015, the author also identifies a potential misconception for each incorrect response or partially correct/incorrect response identified at 1015.

After selecting the format, the author prepares a written description of the question, the correct answer(s), the partially correct and/or incorrect response(s), grouped by sets of rules representing potential misunderstandings and feedback commentary to be given to the test taker. This written description could be in XML, in description words, or in some predefined template that the author fills out, or some other way to convey what the author wishes the question to include.

After 1015, the author of the question or another person prepares (at 1020) the XML code specification of the question. In some embodiments, the XML code (1) specifies the question, (2) defines the sets of rules for identifying and matching the test taker's responses, and (3) for each set of rules, includes feedback that specifies the test taker's response as matching a correct answer or as reflecting a possible misunderstanding of the test taker. An example of an XML representation of a question will be provided in section IIIB.

One of ordinary skill in the art will realize that other embodiments might author puzzle-like questions differently than the manner illustrated in FIG. 10. For instance, some embodiments might require the author to utilize a particular program with a particular user interface to specify DND, FIB, MCSA, or MCMA questions. Some of these embodiments might then provide an automated manner for generating the XML for such questions. Other embodiments might utilize other forms of puzzle-like questions. For instance, some embodiments might use learning interactions that ask the test taker to match members of one set of items with members of another set of items by using lines to connect the members in the different sets.

### B. Overview of the Rules

As mentioned above, some embodiments use XML to specify questions. Other embodiments, however, might utilize other formats to specify a question. In the embodiments that use XML to specify a question, some embodiments place sets of rules in an XML file that can be used to categorize a set of possible responses to the question as being correct, partially correct, partially incorrect, or incorrect. The set of rules in some embodiments can be composed of: (1) containment rules, (2) relationship rules, and (3) conditional rules.

For this exposition, we refer to a single set of rules that can distinguish possible test taker responses as a “Rule Set”. A Rule Set is further defined as including the feedback commentary for any test taker response that matches the rules and a name (or code) that can be used to indicate in a data store whether the Rule Set that matched the response that the test taker provided is correct, partially correct, or partially incorrect.

In some embodiments, containment rules are used to define the responses that a test taker might provide to a particular question. For a DND or FIB question, the set of containment rules in some embodiments anticipate what a slot or blank may include (that is, contain) in a potential test taker response. For instance, the set of containment rules may specify that a potential response might include (1) a selection A, (2) a selection A OR a selection B, (3) a selection A AND a selection B, or (4) any Boolean combination of choices (e.g., A OR (B AND C)). For MCMA questions, the XML syntax includes names for each potential selection in a set of prompts with which the test taker can answer an MCMA question. These names are similar to the names of the DND tiles and FIB sets of words and phrases. Hence, just like the DND tiles and FIB possible responses, the responses to an MCMA question can be analyzed with a containment rule.

The set of relationship and conditional rules in some embodiments are also used to define whether a response is correct, partially correct, partially incorrect, or incorrect. The combination of containment rules, relationship rules, and conditional rules in some embodiments define whether a response is correct, partially correct, partially incorrect, or incorrect.

In using the containment, relationship, and/or conditional rules, to formulate a Rule Set,

(1) the Rule Set is named

(2) feedback commentary, where appropriate, explaining the misunderstanding or commenting on why the response is correct, is associated with each named Rule Set,

(3) each Rule Set is examined in order of definition (i.e., in the order that the Rule Sets are defined in the XML), and

(4) a mechanism is provided to specify default commentary that is given to the test taker if none of the Rule Sets matches the test taker response.

In some embodiments, a set of relationship rules may include (1) an equal relationship rule, (2) an empty (not-equal) relationship rule, and (3) a not-empty relationship rule.

The equal relationship rule specifies that the contents of two slots (e.g., numbers, text, or tiles placed into slots) must be identical to each other. The empty relationship rule specifies that the contents of two slots must not overlap. In other words, the empty relationship rule specifies that two slots cannot have the same contents. The not-empty relationship rule specifies that two slots should have at least one component (slot, text) that is identical.

In some embodiments, the set of conditional rules defines conditions that must occur in analyzing the test taker responses for slots within a question (e.g., a selection option in an MCMA question, the tiles in a slot in a DND question, test text in a slot in a FIB question). In some embodiments, the set of conditional rules includes Boolean combinations of other rules for the antecedent clause (If) and/or the consequence clause (Then).

The “If” rule specifies that when a first combination of slot responses occurs, then a particular second combination of slot responses must occur. For example, if slot 1 contains tile 2, then slot 2 must contain tile 4.

### C. Examples

### Example 1

### MCMA

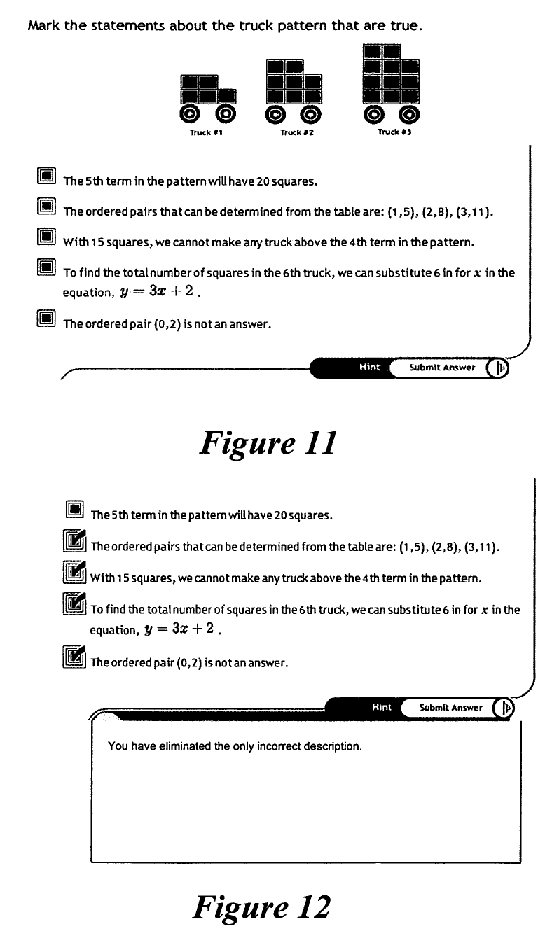

FIGS. 11-12 illustrate an MCMA example that is described in order to elaborate on how some embodiments utilize a rule-based XML technique to represent a question. FIG. 11 illustrates an initial presentation of an MCMA question. This question asks a test taker to select each true statement in a group of statements. FIG. 12 then illustrates the presentation of the MCMA question after the test taker has provided a response that matches the correct answer.

The XML for this problem, which uses LaTeX to define mathematical expressions, is shown in Table 1 below. Note that the tag <prompt> should be interpreted as a slot plus labeling information.

TABLE 1

| | |
|---|---|
| (1) | <page> |
| | <text>Mark the statements about the truck pattern that are true.</text> |
| | <resource name=“threetrucks”/> |
| | <question design=“MCMA” height=“470” columns=“1”> |
| | <prompt name=“1”>The 5th term in the pattern will have 20 squares.</prompt> |
| | <prompt name=“2”>The ordered pairs that can be determined from the table are: (1,5), (2,8), |
| | (3,11 ).</prompt> |
| | <prompt name=“3”>With 15 squares, we cannot make any truck above the 4th term in the |
| | pattern.</prompt> |
| | <prompt name=“4”>To find the total number of squares in the 6th truck, we can substitute 6 in for |
| | <mf>x</mf> in the equation, <math>y = 3x +2</math>.</prompt> |
| | <prompt name=“5”>The ordered pair (0,2) is not an answer.</prompt> |
| (2) | <ruleset name=“correct”> |
| | <rule type=“select””><prompt name=“2”></rule> |
| | <rule type=“select””><prompt name=“3”></rule> |
| | <rule type=“select””><prompt name=“4”></rule> |
| | <rule type=“select””><prompt name=“5”></rule> |
| | <feedback> You have eliminated the only incorrect description. </feedback> |
| | </ruleset> |
| (3) | <ruleset name=“incorrect”> |
| | <rule type=“select””><prompt name=“1”></rule> |
| | <feedback> The table patterns show the ordered pairs. The equation can be used to find the total |
| | number of squares in each truck.</feedback> |
| | </ruleset> |
| (4) | <hint>Use the table and graph to guide your reasoning. The ordered pairs are contained in the |
| | table's 1st and 3rd column.</hint> |
| | </question> |
| | </page> |

In this table, the XML starting at section (1) declares the page to have some text, a picture and then a question defined to be an MCMA question that is to be shown on the screen at a given height and in a single column. There are five prompts named 1-5. There are two sets of rules defined starting at section (2), one named “correct” and the other “incorrect”. Each has feedback that can be given to the test taker. Both sets of rules consist of the section containment rule, denoting here which slot for each prompt should be selected. Section (4) then provides a hint that the test taker can request.

If the author wished to comment on selecting prompt 3 and no other prompt, then an additional rule set could be added, namely

<ruleset name=“partiallycorrect”>
<rule type=“select””><prompt name=“3”></rule>
<feedback> You have made a correct selection but there are several
ways to describe the pattern</feedback>
</ruleset>

### Example 2

### DND

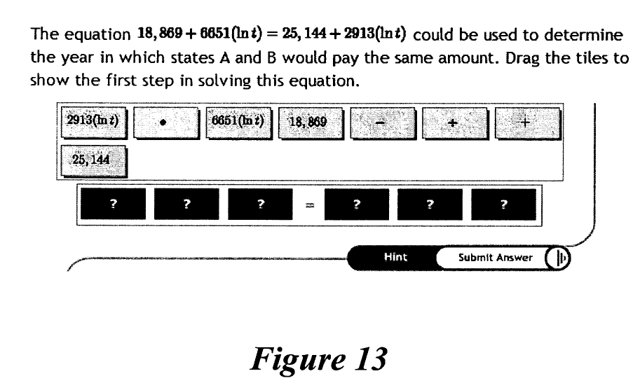

FIG. 13 illustrates a DND example that will now be described in order to further elaborate on how some embodiments utilize a rule-based XML technique to represent a question. This example is a simple Algebra problem but it can have a complex set of responses. This example thus demonstrates the complexity in responses that can be handled with a simple set of rules.

The XML for this problem, which uses LaTeX to define mathematical expressions, is shown in the Table 2 below.

TABLE 2

| | |
|---|---|
| (1) | <page> |
| | <text>The equation <math>18,869 + 6651 ( \ln t) = 25, |
| | 144 + 2913 (\ln t)</math> could be used to determine the |
| | year in which states A and B would pay the same amount. Drag the |
| | tiles to show the first step in solving this equation. </text> |
| (2) | <question design=“DND”> |
| | <palette position=“top” /> |
| | <grid /> |
| (3) | <tile name=“1” ><math>18,869</math> </tile> |
| | <tile name=“2” ><math>6651 (\ln t)</math> </tile> |
| | <tile name=“3” ><math>25,144</math> </tile> |
| | <tile name=“4” ><math>2913 (\ln t)</math> </tile> |
| | <tile name=“5” ><math> + </math> </tile> |
| | <tile name=“6” ><math> − </math> </tile> |
| | <tile name=“7” ><math> \bullet </math> </tile> |
| | <tile name=“8” ><math> \div </math> </tile> |

In Table 2, section (1) declares a new page and its initial paragraph text, and section (2) starts the definition of the DND, which defines layout information, here that the palette of tiles should be placed at the top and above the grid of slots. Section (3) then declares the eight tiles that will appear at the top. The tile numbers in Table 2 do not match the order that the tiles appear in FIG. 13 because some embodiments differently transpose the order of the titles for different test takers to prevent cheating.

Below, Table 3 illustrates the next part of the XML, which defines the layout of the slots in a table structure (section 4). In Table 3, section 5 is the beginning of the set of rules for a correct response. The first part of this set of rules specifies how the slots and tiles are matched. These are the “containment” rules in the set of rules, which make liberal use of Boolean combinations to express which tiles can be placed in which slots, indicating that some slots can contain several possible tiles. Notice there is just one cell (set of slots). It contains three slots followed by an equals sign (=) and then three more slots. The slots are numerically named.

TABLE 3

| | |
|---|---|
| (4) | <cell > |
| | <slot name=“1”/> |
| | <slot name=“2”/> |
| | <slot name=“3”/> |
| | <math> = </math> |
| | <slot name=“4”/> |
| | <slot name=“5”/> |
| | <slot name=“6”/> |
| | </cell > |
| (5) | <ruleset name=“correct”> |
| | <rule type=“contains”> |
| | <slot name=“1”/> |
| | <or> |
| | <tile name=“1” /> |
| | <tile name=“2” /> |
| | <tile name=“3” /> |
| | <tile name=“4” /> |
| | </or> |
| | </rule> |
| | <rule type=“contains”> |
| | <slot name=“2”/> |
| | <tile name=“6” /> |
| | </rule> |
| | <rule type=“contains”> |
| | <slot name=“3”/> |
| | <or> |
| | <tile name=“3” /> |
| | <tile name=“4” /> |
| | <tile name=“1” /> |
| | <tile name=“2” /> |
| | </or> |
| | </rule> |
| | <rule type=“contains”> |
| | <slot name=“4”/> |
| | <or> |
| | <tile name=“4” /> |
| | <tile name=“3” /> |
| | <tile name=“1” /> |
| | <tile name=“2” /> |
| | </or> |
| | </rule> |
| | <rule type=“contains”> |
| | <slot name=“5”/> |
| | <tile name=“6” /> |
| | </rule> |
| | <rule type=“contains”> |
| | <slot name=“6”/> |
| | <or> |
| | <tile name=“2” /> |
| | <tile name=“1” /> |
| | <tile name=“3” /> |
| | <tile name=“4” /> |
| | </or> |
| | </rule> |
| | ...continued in Table 4... |

Table 4 below illustrates certain rules and constraints regarding the relationship between the tiles and slots for the example illustrated in FIG. 13. The first grouping of rules in the set (designated as section 6) declares that the tiles placed in certain slots cannot be identical. The rule that makes this declaration is the “empty” rule, i.e., the intersection of two slots has to be the empty set. The second grouping of rules (designated as section 7) declares a number of constraints that say if a slot contains a particular tile, then another identified slot must contain an identified tile.

TABLE 4

| | |
|---|---|
| (6) | <rule type=“empty”> |
| | <slot name=“1” /> |
| | <slot name=“6” /> |
| | </rule > |
| | <rule type=“empty”> |
| | <slot name=“3” /> |
| | <slot name=“4” /> |
| | </rule > |
| | <rule type=“empty”> |
| | <slot name=“1” /> |
| | <slot name=“3” /> |
| | </rule > |
| | <rule type=“empty”> |
| | <slot name=“1” /> |
| | <slot name=“4” /> |
| | </rule > |
| | <rule type=“empty”> |
| | <slot name=“3” /> |
| | <slot name=“6” /> |
| | </rule > |
| | <rule type=“empty”> |
| | <slot name=“4” /> |
| | <slot name=“6” /> |
| | </rule > |
| (7) | <rule type=“if”> |
| | <slot name=“1” /> <tile name=“1” /> |
| | <slot name=“3” /> <tile name=“3” /> |
| | </rule > |
| | <rule type=“if”> |
| | <slot name=“3” /> <tile name=“1” /> |
| | <slot name=“1” /> <tile name=“3” /> |
| | </rule > |
| | <rule type=“if”> |
| | <slot name=“4” /> <tile name=“1” /> |
| | <slot name=“6” /> <tile name=“3” /> |
| | </rule > |
| | <rule type=“if”> |
| | <slot name=“6” /> <tile name=“1” /> |
| | <slot name=“4” /> <tile name=“3” /> |
| | </rule > |
| | <rule type=“if”> |
| | <slot name=“1” /> <tile name=“2” /> |
| | <slot name=“3” /> <tile name=“4” /> |
| | </rule > |
| | <rule type=“if”> |
| | <slot name=“3” /> <tile name=“2” /> |
| | <slot name=“1” /> <tile name=“4” /> |
| | </rule > |
| | <rule type=“if”> |
| | <slot name=“4” /> <tile name=“2” /> |
| | <slot name=“6” /> <tile name=“4” /> |
| | </rule > |
| | <rule type=“if”> |
| | <slot name=“6” /> <tile name=“2” /> |
| | <slot name=“4” /> <tile name=“4” /> |
| | </rule > |
| | <rule type=“if”> |
| | <slot name=“1” /> <tile name=“1” /> |
| | <slot name=“4” /> <tile name=“4” /> |
| | </rule > |
| | <rule type=“if”> |
| | <slot name=“1” /> <tile name=“3” /> |
| | <slot name=“4” /> <tile name=“2” /> |
| | </rule > |
| | <rule type=“if”> |
| | <slot name=“1” /> <tile name=“2” /> |
| | <slot name=“4” /> <tile name=“3” /> |
| | </rule > |
| | <rule type=“if”> |
| | <slot name=“1” /> <tile name=“4” /> |
| | <slot name=“4” /> <tile name=“1” /> |
| | </rule > |
| | <feedback>some text here to comment on the correct |
| | response</feedback> |
| | </ruleset> |

These rules isolate the possible correct answers. The complexity in terms of number of rules needed to specify multiple correct answers comes because equality (=) is commutative, and any one of the terms could be subtracted from its respective side. Hence, the author could be willing to accept the following answers:

18,869−25,144=2913(ln t)−6651(ln t)

6651(ln t)−2913(ln t)=25,144−18,869

2913(ln t)−6651(ln t)=18,869−25,144

25,144−18,869=6651(ln t)−2913(ln t)

Finally, Table 5 illustrates the portion of the XML that includes a declaration of a hint and the incorrect feedback. Here the rule type “any” declares that this set of rules matches the test taker's response, regardless of what is the response.

TABLE 5
<hint>Consider a simplified equation such as <math>18 + 66x =
25 + 29x.</math> What would you do first to solve this
equation?</hint>
<ruleset name=“incorrect”>
<rule type=“any”/>
<feedback>Consider a simplified equation: <math>18 + 66x =
25 + 29x.</ math> What would you do to gather like terms?</feedback>
</ruleset>
</dnd>
</essay>

In some embodiments, the XML declaration syntax for DND and FIB is slightly different in deference to the fact that FIB answers are provided as answer sets in which equally acceptable terms are listed, while DND answers are individual tiles.

### Example 3

### FIB

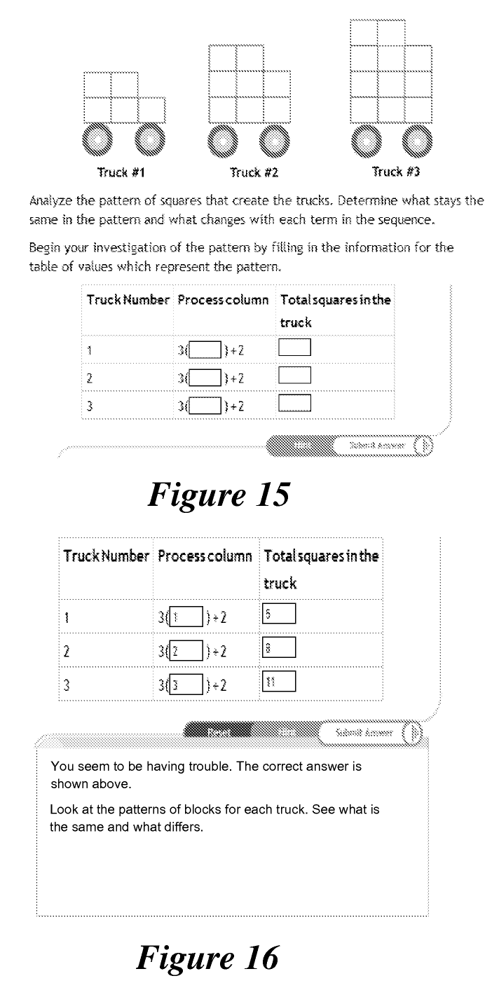

FIGS. 15-16 illustrate a FIB question, where, in this case, sets of rules for both correct and partially incorrect responses are identified. FIG. 15 illustrates an initial presentation of a FIB question, whereas FIG. 16 illustrates the presentation of the FIB question after the test taker has filled in the blanks and submitted the response.

Table 6 provides the XML for this problem, which uses LaTeX to define mathematical expressions.

TABLE 6

| | |
|---|---|
| (1) | <essay> |
| | <resource name=“smalltruck”/> |
| | <resource name=“mediumtruck” /> |
| | <resource name=“largetruck” /> |
| | <question design=“FIB” > |
| | <layout design=“table” stripspaces=“yes” /> |
| (2) | <input name=“1”><item>1</item></input> |
| | <input name=“2”><item>2</item></input> |
| | <input name=“3”><item>3</item></input> |
| | <input name=“4”><item>5</item></input> |
| | <input name=“5”><item>8</item></input> |
| | <input name=“6”><item>11</item></input> |
| | <input name=“7”><item>9</item></input> |
| | <input name=“8”><item>12</item></input> |
| | <input name=“9”><item>18</item></input> |
| (3) | <grid cols=“3” rows=“4” /> |
| | <cell><text><b>Truck Number</b></text></cell> |
| | <cell><text><b>Process column</b> </text></cell> |
| | <cell><text><b>Total squares in the truck</b></text></cell> |
| | <cell><text>1</text></cell> |
| | <cell><text>3(</text><slot name=“1” /><text>) + 2</text></cell> |
| | <cell><slot /></cell> |
| | <cell><text>2</text></cell> |
| | <cell><text>3(</text><slot /><text>) + 2</text></cell> |
| | <cell><slot /></cell> |
| | <cell><text>3</text></cell> |
| | <cell><text>3(</text><slot /><text>) + 2</text></cell> |
| | <cell><slot /></cell> |
| (4) | <ruleset name=“correct”> |
| | <rule type=“contains”><slot name=“1”><input name=“1”></rule> |
| | <rule type=“contains”><slot name=“2”><input name=“4” /></rule> |
| | <rule type=“contains”><slot name=“3”><input name=“2” /></rule> |
| | <rule type=“contains”><slot name=“4”><input name=“5” /></rule> |
| | <rule type=“contains”><slot name=“5”><input name=“3” /></rule> |
| | <rule type=“contains”><slot name=“6”><input name=“6” /></rule> |
| | <feedback> You have correctly formed the patterns that maintains the |
| | constant number of blocks at the top of each truck, while using the |
| | multiplication of 3 blocks per row as the trucks get bigger </ |
| | feedback> |
| | </ruleset> |
| (5) | <ruleset name=“perror”> |
| | <rule type=“or”> |
| | <rule type=“contains”><slot name=“2”><input name=“7”></rule> |
| | <rule type=“contains”><slot name=“4”><input name=“8” /></rule> |
| | <rule type=“contains”><slot name=“6”><input name=“9” /></rule> |
| | </rule> |
| | <feedback>It is possible that you are adding before multiplying. |
| | Notice that the parentheses indicate multiplication which takes place |
| | before the addition. |
| | </feedback> |
| | </ruleset> |
| (6) | <ruleset name=“incorrect”> |
| | <rule type=“any”/> |
| | <feedback>Look at the pattern of blocks for each truck. See what is |
| | the same and what differs.</feedback> |
| | </ruleset> |
| | </question> |
| | </essay> |

The presentation of the questions is specified in the first section of the XML given in Table 6. The illustrations of trucks and two textual paragraphs precede the declaration of the question (section (1)).

In section (2), various characters (words) that the test taker can type into the slots are declared and named. The test taker can type any characters, but these particular characters are of interest in analyzing the test taker's responses. Notice that the named inputs each consist of one possible number. Embedding multiple <item> tags within an <input> declares a set of possible words or phrases to expect.

In section (3), the table structure of three columns and four rows is declared indicating slots that go into various cells along with text forming mathematical expressions.

Then in section (4), containment rules are used to declare the expected correct response as shown in FIG. 16. Section (5) identifies a partially incorrect response with anticipated inputs that could indicate applying the precedence ordering for multiplication and addition incorrectly. Finally section (6) captures all other responses as incorrect.

One of ordinary skill will realize that any number of sets of rules can be used to identify anticipated inputs by the test taker that might indicate misconceptions about how to solve the problem or carry out the algebra correctly.

### Example 4

### DND Revisited

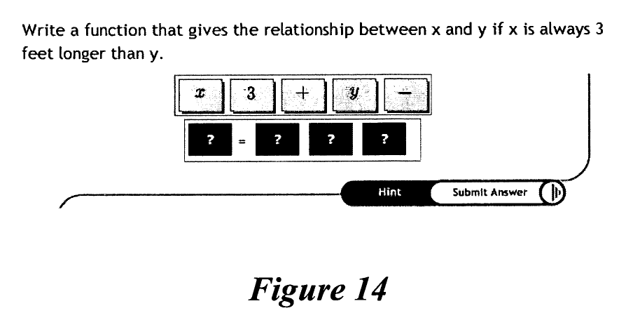

FIG. 14 illustrates the same question that was described in Example 2. This is the same DND question that was described above by reference to FIG. 1-3. In FIG. 14, the tiles are arranged slightly differently than in FIG. 1. The question posed in FIG. 14 is a DND question that displays four slots, and 5 tiles: x, y, 3, +, and −. The test taker is asked to write an expression that represents x in terms of y, where x is 3 feet longer than y. The author might consider the correct answer to be y=x−3. However, given the position of the equality in the layout of the slots, the author might consider the following answers as partially correct:

x=y+3

x=3+y

Alternatively, the author might consider all these three answers as the completely correct answer.

Table 7 illustrates the definition of the tiles.

TABLE 7

<tile name=“1” ><math>x</math></tile>
<tile name=“2” ><math>y</math></tile>
<tile name=“3” ><math>3</math></tile>
<tile name=“4” ><math>+</math></tile>
<tile name=“5” ><math>−</math></tile>

Table 8 illustrates the set up for the display of slots followed by the matching rules. The set up for the display of slots are specified in Section (1) followed by Section (2), which specifies the matching rules.

TABLE 8

| | |
|---|---|
| (1) | <cell> |
| | <slot name=“1”></slot> |
| | <text> = </text> |
| | <slot name=“2”></slot> |
| | <slot name=“3”></slot> |
| | <slot name=“4”></slot> |
| | </cell> |
| (2) | <ruleset name=“correct”> |
| | <rule type=“contains”> |
| | <slot name=“1”/> |
| | <or><tile name=“1” /><tile name=“2” /></or> |
| | </rule> |
| | <rule type=“contains”> |
| | <slot name=“2”/> |
| | <or><tile name=“2” /> |
| | <tile name=“3” /> |
| | <tile name=“1” /> |
| | </or> |
| | </rule> |
| | <rule type=“contains”> |
| | <slot name=“3”></slot> |
| | <or><tile name=“4” /><tile name=“5” /></or> |
| | </rule> |

Table 9 illustrates the relationship and conditional rules that specify all three possible correct answers as the correct answer.

TABLE 9

```
<rule type=“empty”>  //slot 1 and 2 can not contain the same tiles
    <slot name=“1” />
    <slot name=“2” />
</rule >
<rule type=“empty”>  //slot 2 and 4 can not contain the same tiles
    <slot name=“2” />
    <slot name=“4” />
</rule >
<rule type=“if”> //if slot 1 has x, then slot 2 is 3 or y
    <slot name=“1” /> <tile name=“1” />
    <rule type=“or”>
    <slot name=“2” /> <tile name=“3” />
    <slot name=“2” /> <tile name=“2” />
    </rule>
</rule >
<rule type=“if”>  //if slot 1 has y, then slot 2 is x
    <slot name=“1” /> <tile name=“2” />
    <slot name=“2” /> <tile name=“1” />
</rule >
<rule type=“if”> //if slot 1 has x then slot 3 is +
    <slot name=“1” /> <tile name=“1” />
    <slot name=“3” /> <tile name=“4” />
</rule >
<rule type=“if”>  //if slot 1 has y, then slot 3 is −
    <slot name=“1” /> <tile name=“2” />
    <slot name=“3” /> <tile name=“5”/>
</rule >
<rule type=“if”>  //if slot 1 has x and slot 2 is y, then slot 4 is 3
    <slot name=“1” /> <tile name=“1” />
    <rule type=“and”>
      <slot name=“2” /> <tile name=“2” />
      <slot name=“4” /> <tile name=“3” />
    </rule>
</rule >
</ruleset>
```

These rules only accept x=y+3, x=3+y, and y=x−3, and treat them all equally as the right answer. However, suppose the author prefers to accept only y=x−3, and to comment on the other choices as correct equations but either not understanding instructions to define y as a function of x or preferred ordering of variables before constants. The author could restrict the contents of each slot with a contains rule, but that approach does not allow the use of alternative sets of rules with a richer set of commentary. Table 10 illustrates an example of the use of such rules and commentary. The rules and commentary provide only a subset of the possible rule patterns for identifying misconceptions.

TABLE 10
<ruleset name=”correct”>

| | |
|---|---|
| <rule type=“equals”> | //slot 1 must contain x |

```
        <slot name=“1” />
        <tile name=“1” />
    </rule >
```

| | |
|---|---|
| <rule type=“equals”> | //slot 2 must contain y |

```
        <slot name=“2” />
        <tile name=“2” />
    </rule >
```

| | |
|---|---|
| <rule type=“equals”> | //slot 3 must contain + |

```
        <slot name=“3” />
        <tile name=“4” />
    </rule >
```

| | |
|---|---|
| <rule type=“equals”> | //slot 4 must contain 3 |

```
        <slot name=“4” />
        <tile name=“3” />
    </rule >
    <feedback>Your answer is correct.</feedback>
</ ruleset >
<ruleset name =”partial”>
```

| | |
|---|---|
| <rule type=“equals”> | //slot 1 must contain y |

```
        <slot name=“1” />
        <tile name=“1” />
    </rule >
```

| | |
|---|---|
| <rule type=“empty”> | //slot 1 and 2 can not contain the same tiles |

```
        <slot name=“1” />
        <slot name=“2” />
    </rule >
```

| | |
|---|---|
| <rule type=“if”> | //if slot 1 has x, then slot 2 is 3 or y |

```
        <slot name=“1” /> <tile name=“1” />
        <rule type=“or”>
            <slot name=“2” /> <tile name=“3” />
            <slot name=“2” /> <tile name=“2” />
        </rule>
    </rule >
```

| | |
|---|---|
| <rule type=“if”> | //if slot 1 has x and slot 2 is y, then |
| | slot 3 is + |

```
        <slot name=“1” /> <tile name=“1” />
        <rule type=“and”>
            <slot name=“2” /> <tile name=“2” />
            <slot name=“3” /> <tile name=“4” />
        </rule>
    </rule >
```

| | |
|---|---|
| <rule type=“if”> | //if slot 1 has x and slot 2 is y, |
| | then slot 4 is 3 |

```
        <slot name=“1” /> <tile name=“1” />
        <rule type=“and”>
            <slot name=“2” /> <tile name=“2” />
            <slot name=“4” /> <tile name=“3” />
        </rule>
    </rule >
    <feedback>Your equation was correct, but you expressed x as a
    function of y, rather than y as a function of x. Remember that x is the
    independent variable and y is the dependent variable.</feedback>
</ ruleset >
```

The rules given in Table 10 could also include rules that enumerate anticipated wrong answers and associated commentary for these answers.

### IV. INTERACTIONS WITH TEST TAKERS

Some embodiments of the invention provide assessment analysis in real-time to test takers as they are answering questions, including puzzle-like questions. Some embodiments also provide such analysis in reports that are provided to the test takers, teachers, administrators, and/or other individuals. As further described below in Section V, such reports can be generated in some embodiments by performing queries on data stores that store records relating to the test taker responses to the different questions. However, before describing the generation of such reports, this section describes how some embodiments perform real-time analysis for the test takers.

### A. Software Architecture

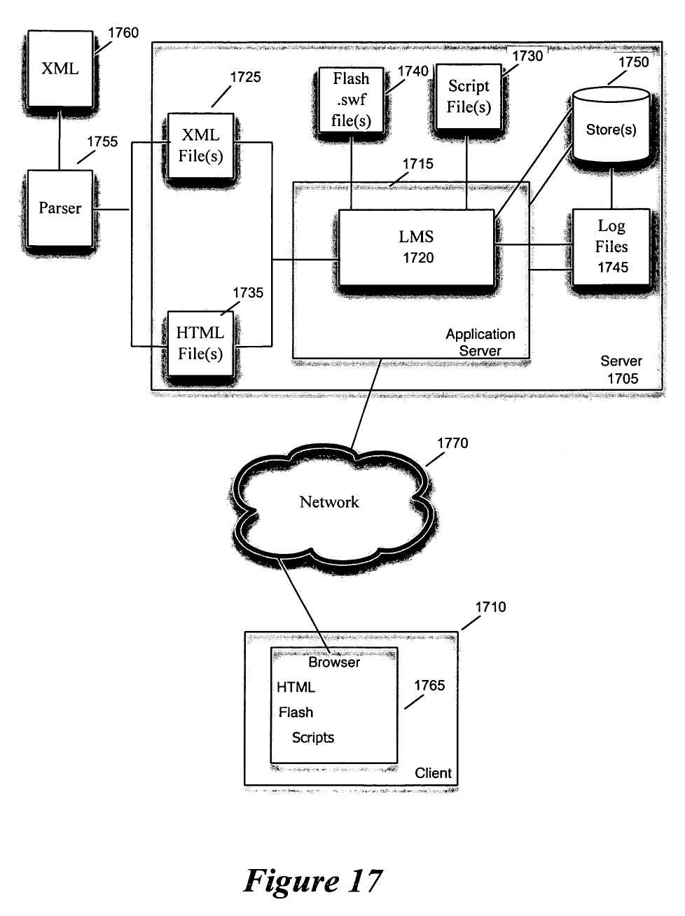

FIG. 17 presents a software architecture diagram that illustrates how some embodiments display a set of questions to a test taker and record the test taker's interaction. These embodiments utilize a client-server model in which a test taker works on a client computer 1710 that receives from the server 1705 code for displaying questions and rules for analyzing the responses to the questions. In some of the embodiments described below, the client computer presents questions using a Flash player. Other embodiments, however, might utilize other interaction mechanisms for displaying questions and handling the test taker interactions.

As shown in FIG. 17, the server 1705 has two application programs executing on it. These are the application server 1715 and the learning management system (LMS) application 1720. The server also stores several types of files, which are (1) a set of one or more files containing XML code 1725, (2) a set of one or more files containing script code 1730, (3) a set of one or more files containing HTML code 1735, (4) a set of one or more Flash (.swf) files 1740, and (5) possibly a set of one or more log files 1745. The server also includes a set of one or more data stores 1750. Even though FIG. 17 presents the applications 1715 and 1720, the files 1725, 1730, 1735, 1740, and 1745, and the data store(s) 1750 on one server 1705, one of ordinary skill will realize that other embodiments may distribute these applications, files, and data store(s) on several different computers in different combinations.

As shown in FIG. 17, a parser 1755 generates the HTML file(s) 1735, possibly language script file(s) called on by the HTML 1730, and XML file(s) 1725 by parsing one or more XML documents 1760. The set of XML documents 1760 contain the definitions of questions 1720 including their analysis rules.

The XML file(s) 1725 contain the data, in the form of XML tags that are used to display the questions and handle the analysis of the test taker responses. The Flash files 1740 provide the programs executed by a Flash player on the client computer 1710 that (1) load the XML parsed by each Flash program, (2) create the actual display of each question based on the directions given by this XML, as well as (3) handle the test taker interaction. For instance, in responding to a question, a test taker might need to drag and drop tiles into slots. The Flash player allows the test taker to perform such an operation.

In some embodiments, the XML document 1760 is written by a human being and can contain errors. The Parser 1755 examines this XML document 1760, reports any errors and, if none, generates the XML file 1725. The Flash program can rely on the XML file 1725 being correct syntactically.

Some embodiments use at least two different Flash programs 1740 for at least two different question types (e.g., one Flash file 1740 for DND questions and one Flash file 1740 for FIB questions). Other embodiments may specify one Flash program 1740 for multiple question types.

The application server 1715 provides the functionality of a standard web-based client-server application interface. It interprets requests (e.g., http requests) from a browser 1765 on the client computer 1710. When these requests are for the LMS application 1720, the application server 1715 routes these requests to the LMS application 1720. It also routes responses from the LMS application 1720 to the client's browser 1765. In some embodiments, the application server 1715 is a standard application server (e.g., the Zope application server, which is written using the Python programming language).

As mentioned above, the application server 1715 routes to the LMS application 1720 requests from the browser 1765 regarding different questions. The LMS application is the application that processes these requests. For instance, when the test taker selects a curriculum page or test page that contains a particular DND question for viewing, the browser 1765 would send a request to run a particular Flash program. This Flash program is capable of displaying and handling the interaction with the test taker, and then, when the test taker submits a response, the Flash player passes on the information about the test taker interaction to the application server 1715, which routes this information to the LMS application 1720. The application then stores the received data into the data store. In particular, the data includes the name of the rule set that matched the test taker response. Storing this name allows a reporting program to present which named rule set (equated to which misunderstandings if the response is not “correct”) matched the test taker's response.

As shown in FIG. 17, the application server 1715 communicates with the client browser 1765 through a network. Examples of such a network include a local area network (LAN), a wide area network (WAN), and a network of networks, such as the Internet.

The client browser 1765 manages the presentation of the actual screens that the test taker sees. These screens are created by the client browser by loading the HTML 1735 and scripts 1730 files. Included in the HTML can be instructions to embed an application such as a named Flash program 1740.

In handling the test taker's interaction with a presentation of a particular question, the Flash program records various test taker interactions. It also uses the containment, relationship, and conditional rules (which it receives in the XML file 1725) associated with a particular question in order to perform real-time distractor analysis. Based on this analysis, the Flash player provides feedback to the test taker that identifies a potential test taker misunderstanding when the test taker provides a partially correct or incorrect response). In some embodiments, the Flash player also records each instance that it provided feedback to the test taker. This real-time analysis is further described below in section IIIB.

When the test taker decides to submit an answer (e.g., clicks on a submit button in a content frame that poses a question), the browser or Flash player sends an http request to the LMS application 1720 via the application server 1715. This request encodes information that will be captured in a database, specifically the request should encode which screen the question appeared on, which question was presented, which data was used to create the question, whether a hint was given, how many times the test taker has responded, the name of the rule set that matched the test taker response, and an encoding of the actual test taker response.

Upon receiving this request, the LMS application 1720 moves the received information into the data store 1750.

As indicated in the previous paragraph, several of the parameters are parameters that are kept by the Flash player of the browser 1765 regarding a particular presentation of a question to a test taker. In this example, these parameters include (1) the number of attempts by the test taker to answer the question, and (2) a flag indicating whether a hint was provided. In addition to these parameters, the database record might store other parameters that the LMS application associates with the http request (e.g., a date/time stamp to indicate the time for receiving the request, a unique sequence ID used for auditing and data correlation purposes).

One example of another transaction that is stored in the data store includes a record of when a question was presented to the test taker. Specifically, when the application server 1715 responds to a request from the client browser 1765 for a particular question, the application server 1715 creates a record in the set of log files 1745 to identify the time the question was presented to the test taker (e.g., to create a record that specifies the test taker, the exam, the question on the exam, and the time the question was transmitted to the test taker). This logged data provides timing data or usage data for later reporting.

In some embodiments, one or more batch processes periodically read the set of log files 1745 to create entries in one or more data stores 1750. The set of data stores are used for performing queries and generating reports for teachers, administrators, and/or other interested parties. In some embodiments, the data store 1750 is formed by two sets of databases. One set of databases is used to store the raw data, while another set of databases is used to store data that have been processed to optimize them for performing reporting queries.

Instead of one or more databases, other embodiments use other data store structures for the set of data stores 1750. FIG. 17 illustrates the data store 1750 as residing on the same server as the set of log files 1745 and the LMS application 1720. However, as mentioned above, some embodiments place this data store, the log file, and/or the LMS application on different computers.

### B. Real-Time Analysis

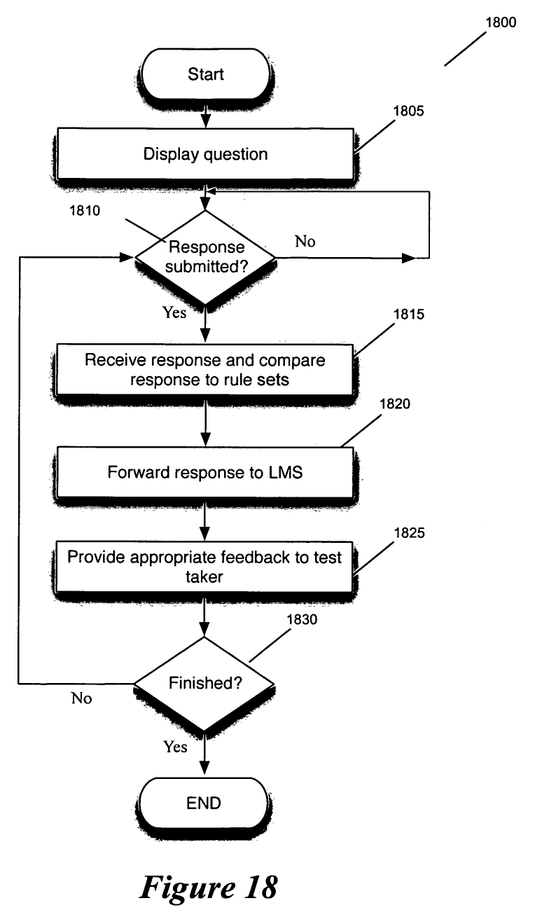

FIG. 18 conceptually illustrates a real-time analysis process 1800 that the browser's Flash player performs in some embodiments. The browser's Flash player in some embodiments performs the operations illustrated in FIG. 18 in the sequence illustrated in these figures. However, the Flash player in other embodiments might not perform all the operations illustrated in this figure and/or might not perform them in the particular nested order that is illustrated in FIG. 18. Accordingly, the illustration of FIG. 18 is conceptual as it is meant to convey the logic implemented in some embodiments.

The process 1800 starts when the browser receives a particular question from the LMS application 1720. In some embodiments, the process receives the question along with its associated rules in an XML file from the LMS application. The received rules allow this process (1) to identify correct answer(s), partially correct answers, partially incorrect responses, and/or incorrect responses and (2) to perform real-time analysis, e.g., to identify and present potential misconceptions associated with the responses.

As shown in FIG. 18, the process (at 1805) creates and displays the presentation and stores data regarding when it presented the question to the test taker. In some embodiments, the stored data identify various parameters regarding the question and the test taker, e.g., parameters identifying the test taker, the exam, the time for sending the question, etc. These data might be stored (at 1805) at the client computer 1710, the server 1705, or both.

Next, the process waits at 1810 until it receives a response from the test taker. Once the test taker submits a response, the process uses (at 1815) the rules in the XML file 1725 that it received from the LMS application 1720 in order to determine whether the test taker's response matches one of the Rule Sets. The process then forwards (at 1820) the result of this comparison to the LMS for storage. At 1820, the process also forwards data that specify various parameters regarding the received response. Examples of these parameters include parameters identifying the test taker, the exam, the time for receiving the response, and the test taker's response.

After 1820, the process presents (at 1825) to the test taker feedback (if any) that is associated with the matching Rule Set. The associated feedback is specified in the XML file 1725 that the client browser received from the LMS application 1720. Depending on the matching Rule Set, this feedback might specify the test taker's response as correct or as indicating a misunderstanding that led to the test taker providing an incorrect, partially correct, or partially incorrect response.

After 1825, the process determines (at 1830) whether the test taker should be presented with another chance to provide a response. If so, the process returns to 1810 to await the test taker's next response. Otherwise, the process ends.

### V. REPORTS FOR TEACHERS AND/OR ADMINISTRATORS

The records stored in the log files 1745 and data store(s) 1750 can be used to provide distractor-analysis reports to teachers, administrators, and other interested parties. Specifically, these data can be processed into data stores that can be queried to generate such reports. Sub-section A below describes examples of such data stores, sub-section B describes examples of creating tests, and sub-section C describes examples of reports generated by some embodiments of the invention.

### A. Databases

Some embodiments use multiple databases to form the data store 1750 of FIG. 17. For instance, some embodiments use one database to store raw data regarding the interactions with one or more test takers, while using another database to store data that have been processed to optimize the query operations.

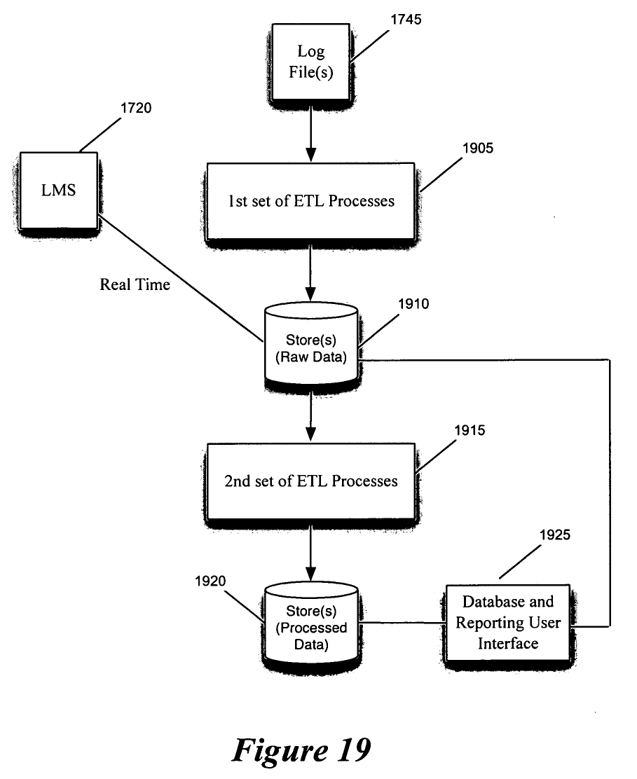

FIG. 19 illustrates one such approach. Specifically, it illustrates a first pre-processing operation 1905 that retrieves data from the set of log files 1745 of FIG. 17 and transforms this data into a format that can be stored in a first database set 1910. Some embodiments perform this operation by using a set of extract, transform, and load (ETL) processes 1905, which might be run in real-time or in batch. As mentioned above, and as shown in FIG. 19, some embodiments have the LMS application store the learning interaction data in real-time.

FIG. 19 also illustrates a second set of operations 1915 that retrieves data from the database set 1910, analyzes this data, and transforms the analyzed and processed data into a format that can be stored in a second database set 1920. In some embodiments, this second set of operations is performed by another set of ETL processes 1915 in batch mode or in real time.

The database set 1920 stores the student interaction data in a processed format that is optimized to speed up queries that might be performed (e.g., queries performed by teachers and/or administrators). For instance, the set of log files 1745 or data store 1750 might contain multiple records for a presentation of a question to a test taker. One record might be created when the question was presented to the test taker, one record might be created when the test taker provided the correct answer, and other records might be created each time the test taker submitted an incorrect response or a partially correct response. In performing its ETL operation, the set of ETL processes 1905 of some embodiments creates a record in the database 1910 for each of these records as the database set 1910 includes the data in a raw unprocessed form.

However, the operations 1915 might merge all of these records into one record that has a couple of additional fields that contain the result of analyzing the data in these records. For instance, the merged record might contain a field for expressing the time it took for the test taker to provide the correct answer. Some embodiments maintain this information in the database set 1920 instead of maintaining the time when the question was presented and the time when the correct answer was received. Other embodiments not only maintain in the database set 1920 the processed data (e.g., the duration before receiving the correct answer) but also store the raw data (e.g., the time when the question was presented and the time when the question was answered correctly). Examples of other processed data that the ETL process set 1915 can generate and the database set 1920 can maintain include the number of times the student provided partially correct or incorrect answers.

### B. Examples of Reports

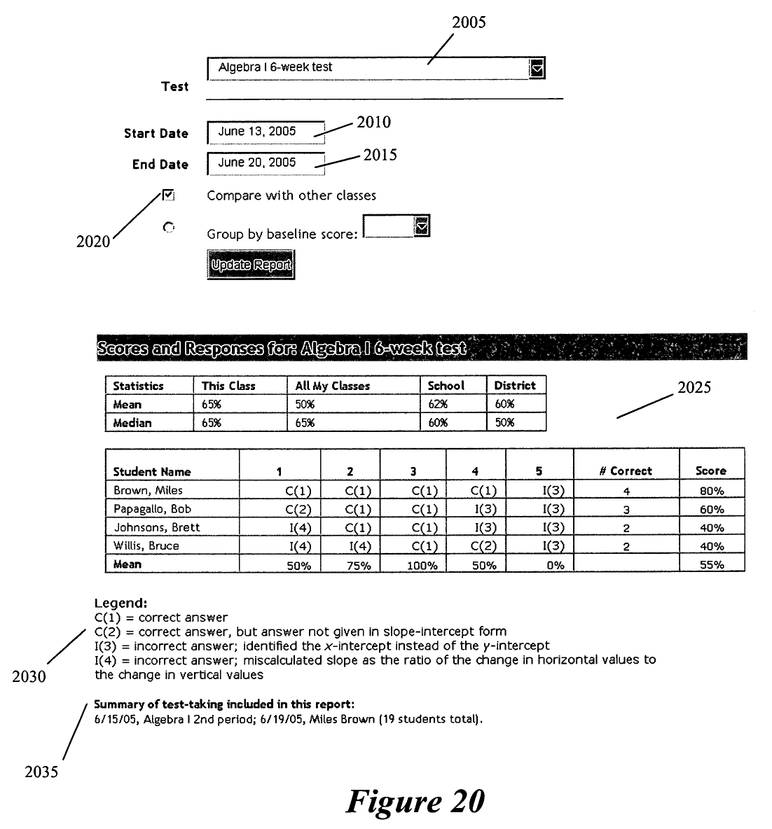

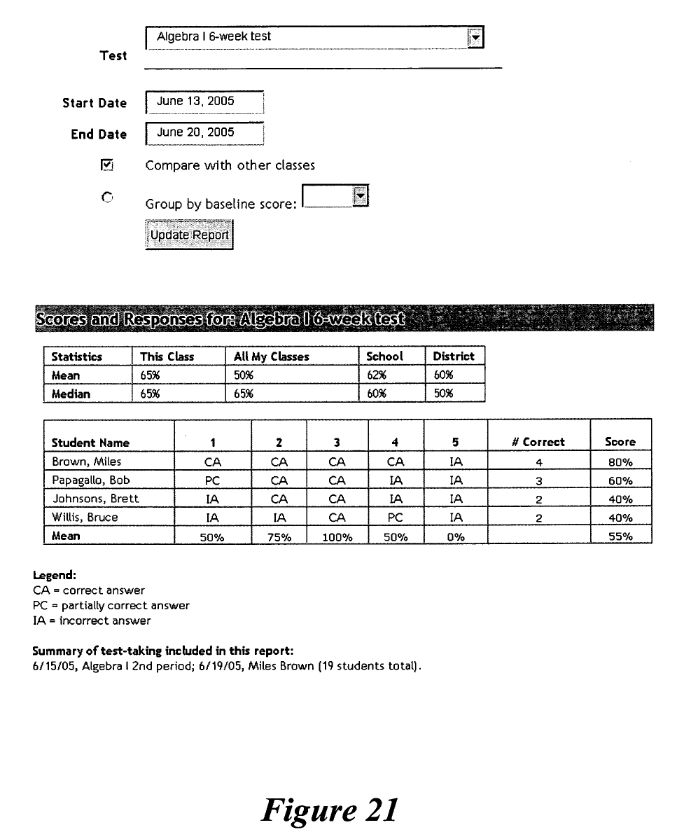

At the time that the test taker answers a question, the assessment author has the choice whether to immediately inform the test taker of the result of analyzing the test taker's response, or to defer this information until the test taker completes the assessment. In some embodiments, on completion of an assessment, the test taker is immediately given a summary report. Another option is to provide a report to the test taker at a later time, including at the time designated by the test taker's teacher or administrator. The form of these summary reports is similar to those shown in FIGS. 20-21, reports for teachers and administrators, but restricted to information about the individual test taker.

Once a test is administered, a reviewer (e.g., teacher or administrator) can review the results by querying the database 1920. A teacher, administrator, or other interested party can run queries on the database 1910 (raw data) or 1920 (processed data) through a user interface 1925. Such queries allow the teacher, administrator, or the interested party to examine the performance of (1) a test taker on a single exam, (2) a test taker on a series of exams, (3) several test takers on a single exam, (4) all test takers on specific question items, and/or (5) a subset of test takers based upon some selection criteria (date, schools, classes, teachers, geography, etc.) or correlations with other data inside or outside the database 1920. Such reports are typical of the kinds of reports provided by similar systems.

Examples of reports that can be generated by querying the database 1920 will now be described by reference to FIGS. 20-21. FIG. 20 illustrates an example of reviewing question-level analysis of a test for multiple test takers. The reviewer can generate such a report by specifying the test and the start and end times for dates to include in the menu selections 2005-2015 of FIG. 20. In this particular example, there is an assumption that test takers belong to a group or class of test takers, and that a report can be selected by name of the test and by reference to a particular class in a school, all classes taught by the same teacher, all classes in a school, or all classes in a school district-all students in which were assigned to take this test. The organization of test takers into groups or classes in this manner is intended to be an example of one way in which to incorporate the ability to give reports. By placing a check mark in box 2020, where test takers are organized as described, the reviewer can have the report compare a particular class's results with those of other classes.

Based on the criteria specified in FIG. 20, the learning application queries the database 1920 and retrieves search results that match the query. In the embodiment illustrated in FIG. 20, these results are displayed in a table format 2025. Summary statistics about this class of test takers and comparative groups are shown in one table. Detailed statistics about each test taker is shown in another table. Each data-containing column represents a particular question (e.g., question 1, 2, 3, etcetera). Another column provides a summary of the number of questions answered correctly, where “Correct” is understood to be one of the names of one of the Rule Sets. The column labeled “Score” displays the percentage correct.

For each test taker and each question, information is displayed in the corresponding table cell. This information could simply be the name of the rule set or it could be a predefined mapping based on conventions set for Rule Set names. The words shown at 2030 could be a mapping from the Rule Set named “c(1)” to the exact words in the report or to some graphical element such as a check mark. Presumably the different questions have differently named Rule Sets, following some conventions set for authoring question items.

In the report illustrated in FIG. 20, summary data on a per question basis is shown as the mean percentage of test takers who answered correctly. Also a summary of which classes or groupings are included in the report can be displayed, as illustrated at 2035.

FIG. 20 illustrates a report for five (5) question items. Perhaps one or two of these name prompts in a multiple choice question. Such naming is likely associated with multiple-choice single answer type questions (MCSA). FIG. 20 thereby indicates the possibility of creating a report that mixes puzzle-like question items with the simpler MCSA questions. FIG. 21 illustrates a similar report, generated for the same search criteria that were specified in the example of FIG. 20, in which perhaps all questions are puzzle-like questions and the naming is to more detailed Rule Sets.

Rule Sets and these names are shown directly in the reports. It is possible to use names such as “Correct”, “Partially correct”, and “Incorrect” for the puzzle-like questions, and “A”, “B”, “D” for the individual prompts of the MCSA questions, rather than the c(1), i(4) format shown in the figures.

The naming of the Rule Sets can be selected so that the misconception identified is more easily understood, such as “Dependent variables” or “Order of operations”. If a table mapping these names to even more description text is made available, that table could be shown in the reports or the text description displayed when the reviewer clicks on the Rule Set name displayed in the table.

The rule-based assessment analysis described above provides significant advantages over existing solutions. For instance, it provides a cost effective approach to providing such an analysis, as it does not rely on complex, computationally intensive algorithms for performing the analysis. Instead, it relies on simple rule based techniques to (1) match a test taker's incorrect or partially correct response to a response enumerated in the rules, and (2) provide feedback to the test taker as to the misconception that is associated with the incorrect or partially correct response.

Moreover, the assessment that it provides corresponds to the association that an expert makes between a misconception and an incorrect or partially correct answer. In addition, this assessment is an assessment that is provided based solely on the test taker's response to a particular question. By identifying the misconception due to an incorrect or partially correct answer to a particular question based solely on the test taker's response to the particular question, the rule-based approach of some embodiments will always provide the feedback regarding the misconception that the expert who designed the question wanted to provide.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method of defining a computer-implemented representation of a question to be presented to a test taker, the method comprising:
specifying a set of rules that defines responses that are potential correct responses a test taker might provide;
associating commentary with the set of rules that describes the potential correct responses;
wherein the question is a question that has multiple possible responses or responses that comprise multiple parts.

2. The method of claim 1, wherein said commentary is for displaying to the test taker if the test taker provides a particular potential response.

3. The method of claim 1, wherein said test taker response is recorded in a data store to specify that the test taker response matched a particular set of potential responses.

4. The method of claim 3 further comprising generating reports based on the data recorded in the data store to identify the test taker response to said question.

5. A method of defining a computer-implemented representation of a question to be presented to a test taker, the method comprising:
specifying a set of rules that defines responses that are potential not correct responses a test taker might provide;
associating commentary with at least one set of rules that describes potential not correct responses;
wherein the question is a question that has multiple possible responses or responses that comprise multiple parts.

6. A method of defining a computer-implemented representation of a question to a test taker, the method comprising:
specifying multiple sets of rules that define responses that are potential correct or not correct responses that the student might provide;
associating commentary for at least one potential response whether it is a correct or not correct response;
wherein the question is a question that has multiple possible responses or responses that comprise multiple parts.

7. The method of claim 6, wherein the multiple sets of rules define a potential mixture of correct and not correct possible responses.

8. A computer-implemented method comprising:
presenting a question to a test taker, wherein the question is a question that has multiple possible responses or responses that comprise multiple parts
performing analysis on a response of the test taker to the question in order to provide feedback commentary to the test taker for a plurality of responses, said analysis not depending on the test taker's response to any other question.

9. The method of claim 8, wherein the question is a multiple choice multiple answer question.

10. The method of claim 8, wherein the question is a drag and drop question.

11. The method of claim 8, wherein the question is a fill-in the blank question.

12. The method of claim 8, wherein performing assessment analysis comprises matching sets of rules that define multiple potential test taker responses to actual test taker response in order to (i) identify a test taker response that is not correct, and (ii) provide commentary that comprises a potential rationale for why the test taker might have responded incorrectly.

13. The method of claim 12, wherein said commentary is for displaying to the test taker if the test taker provides a particular potential response.

14. The method of claim 12 wherein said test taker response is recorded in a data store to specify that the test taker response matched a particular set of potential responses.

15. The method of claim 12 further comprising generating reports based on the data recorded in the data store to identify the test taker response to said question.
